(19) United States
(12) Patent Application Publication
(10) Pub. No.: US 2007/0205562 A1
(43) Pub. Date: Sep. 6, 2007

(54) Seal

(75) Inventor: Chiang-Ling Chien, Nantou County (TW)

Correspondence Address: BROWDY AND NEIMARK, P.L.L.C.;624 NINTH STREET, NW, SUITE 300, WASHINGTON, DC, 20001-5303, US

(73) Assignee: NAK SEALING TECHNOLOGIES CORPORATION, Nantou City (TW)

(21) Appl. No.: 11/452,293

(22) Filed: Jun. 14, 2006

(30) Foreign Application Priority Data
Mar. 3, 2006 (TW) 95107299

(51) Int. Cl. F16J 15/32

(52) U.S. Cl. 277/551

(57) ABSTRACT

A seal includes an inner annular frame, an outer annular frame, a middle annular frame, a first sealing member and a second sealing member. The annular frames have an inner plate, an outer plate and a middle plate between the inner and outer plates parallel to the axis. The first sealing member is provided on the inner annular frame and has a main lip touching the interior side of the middle plate. The second sealing member is provided between the middle plate and the outer plate. The first and second sealing members can prevent lubricator in the tank of the seal from leakage and prevent outer dust from entering the tank.

### BACKGROUND OF THE INVENTION

1. Field of the Invention

The present invention relates generally to a sealing device for a mechanical apparatus, and more particularly to a seal, which can prevent mechanical oil from leakage and has an easier way to replace it.

2. Description of the Related Art

FIG. 1 shows a conventional seal 1, which has is mounted between a sidewall 2a of a hub 2 and a shaft 3 of a wheel machine to prevent lubricator 4 in a tank 2b of the hub 2 from leakage and to bar the outside dust into the tank 2b.

FIG. 2 shows the seal 1 including an inner annular frame 5, an outer annular frame 6 and a middle annular frame 7, which are made of metal and have the same axis. The outer and middle annular frames 6 and 7 are rotated along with the hub 2 and are rotated relative to the inner annular frame 5. The inner annular frame is connected to an sealing member 8, which is made of rubber and has a main lip 8a. The main lip 8a is urged by a spring 9 to deformedly press an interior side 7b of the middle annular frame 7. The sealing member 8 further includes a sealing layer 8b and a sub-lip 8c. The middle annular frame 7 has a plurality of apertures 7a. The sealing member 8, the middle annular frame 7 and the inner annular frame 5 enclose an oil channel 1a in the seal 1, and the oil channel 1a is communicated with the tank 2b via the apertures 7a to have the lubricator 4 between the tank 2b and the oil channel 1a.

The conventional seal 1 has an exterior side 6a of the outer annular frame 6 against a sidewall 2a of the hub 2, an interior exterior side 6b of the outer annular frame 6 touching an exterior side 7a of the middle annular frame 7 directly, and the main lip 8a of the sealing member 8 touching the middle annular frame 7, and the sealing layer 8b of the sealing member 8 touching the shaft 3 to prevent the lubricator 4 in the tank 2b from leakage. In addition, the sub-lip 8c of the sealing member 8 is extended outwardly and touching the outer annular frame 6 to bar dust and particles.

The conventional seal 1 indeed prevents lubricator leakage and baring the dust out of the tank 2b, but it still has some drawbacks, which are:

Typically, the outer annular frame 6 and the middle annular frame 7 are made respectively, therefore when there is size difference between the annular frames, the outer annular frame 6 may be forced to be coupled with the middle annular frame 7 in the following assembling process, but the interior side 6b of the outer annular frame 6 will not tightly touch the exterior side 7a of the middle annular frame 7, furthermore there will be gap therebetween, because they are made of rigid metal. This condition will cause the lubricator 4 leakage. In addition, there will be wear between the outer annular frame 6 and the middle annular frame 7 because they are made of metal. If the conventional seal 1 is found leakage after the outer annular frame 6 has been squeezed into the sidewall 2a of the hub 2, the seal 1 is hard to replace because the outer annular frame 6 and the hub 2 are made of rigid metal. Sometime, it has to break the seal 1 to take it off.

### SUMMARY OF THE INVENTION

The primary objective of the present invention is to provide a seal with capacities of preventing lubricator from leakage and having an easier way to replace.

According to the objective of the present invention, a seal comprises an inner annular frame having an inner plate parallel to an axis. An outer annular frame, which is fitted to the inner annular frame, has an outer plate parallel to the axis. A middle annular frame has a middle plate parallel to the axis, wherein the middle plate is located between the inner plate and the outer plate. A first sealing member has a main lip connected to the inner annular frame, wherein the main lip has an end touching an interior side of the middle plate; and a second sealing member between the middle plate of the middle annular frame and the outer plate of the outer annular frame has opposite sides thereof touching an exterior side of the middle plate and an interior side of the outer plate.

### BRIEF DESCRIPTION OF THE DRAWINGS

FIG. 1 is a perspective view of the conventional seal;

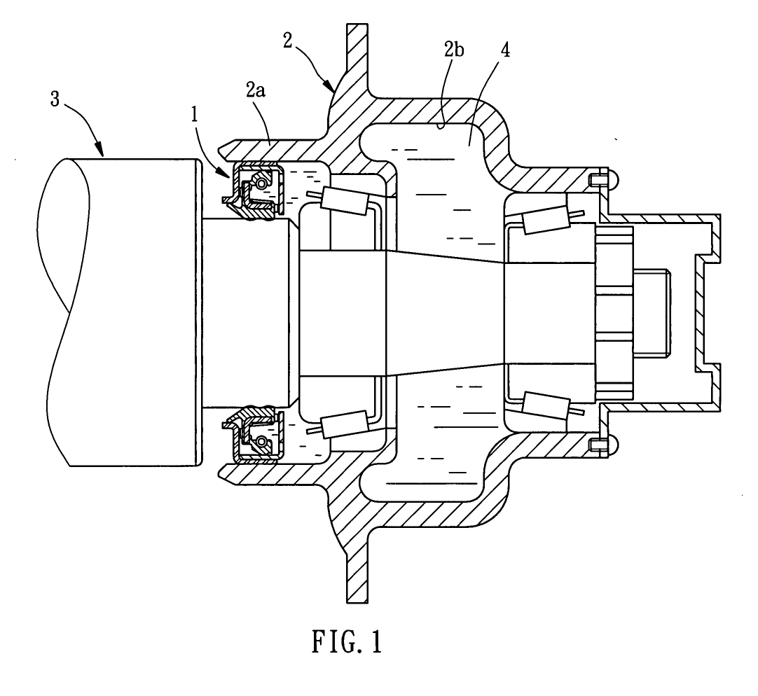

FIG. 2 is a second view of FIG. 1;

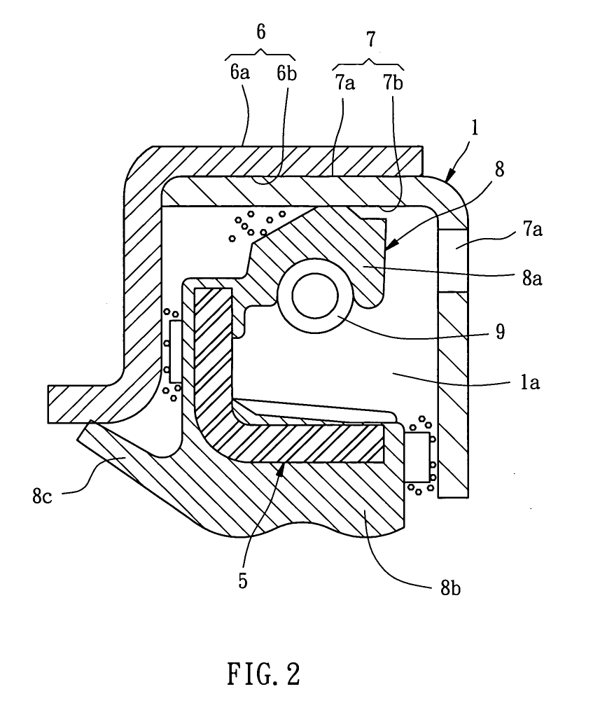

FIG. 3 is a perspective view of a preferred embodiment of the present invention;

FIG. 4 is a sectional view of FIG. 3;

FIG. 5 is a perspective view of the preferred embodiment of the present invention, showing the hub rotating relative to the shaft;

FIG. 6 is a perspective view of the preferred embodiment of the present invention, showing the flanges and protrusions on the first sealing member;

FIG. 7 is a perspective view of the preferred embodiment of the present invention, showing the V-shaped helixes;

FIG. 8 is similar to FIG. 7, showing the straight-bevel-shaped helixes;

FIG. 9 is similar to FIG. 7, showing the two-sectioned helixes; and

FIG. 10 is similar to FIG. 4, showing the second sealing member on the exterior side of the middle plate of the middle annular frame.

### DETAILED DESCRIPTION OF THE INVENTION

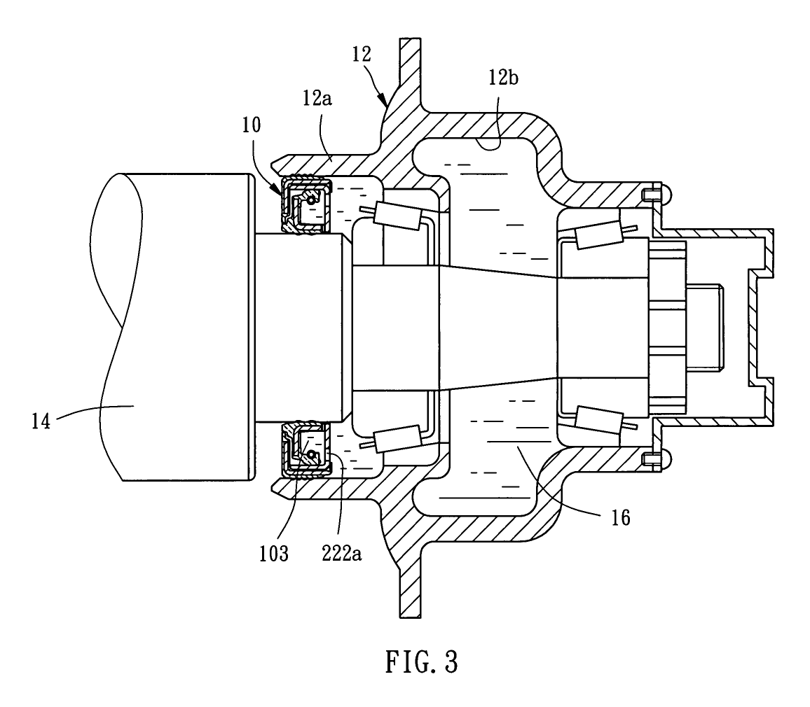

As shown in FIG. 3, a seal 10 of the preferred embodiment of the present invention is fitted to a space between an annular sidewall 12a of a rotary hub 12 and a fixed shaft to prevent lubricator 16 in the tank 12b in the hub from leakage and prevent outside dust from entering the tank 12b.

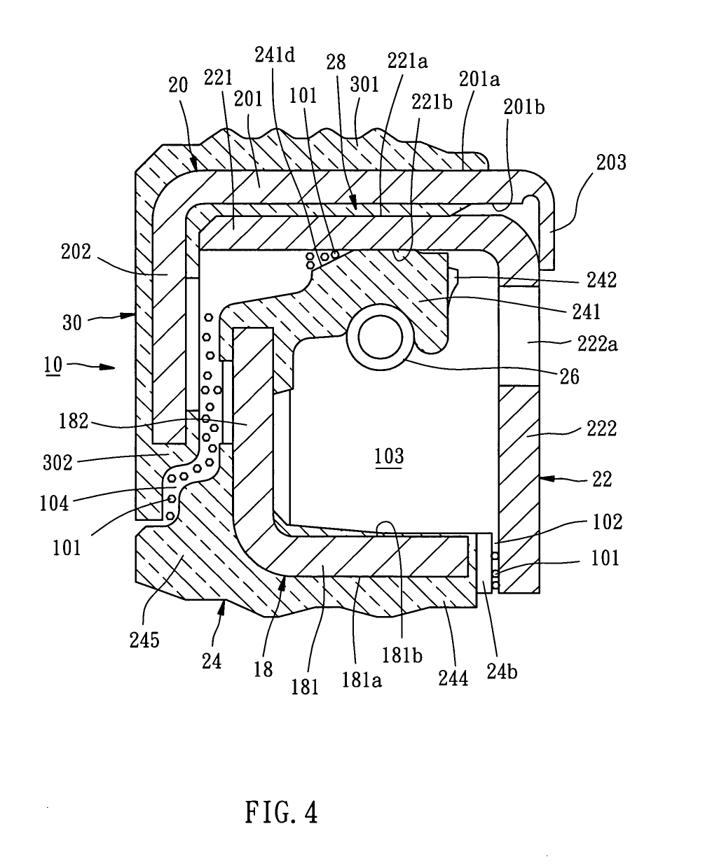

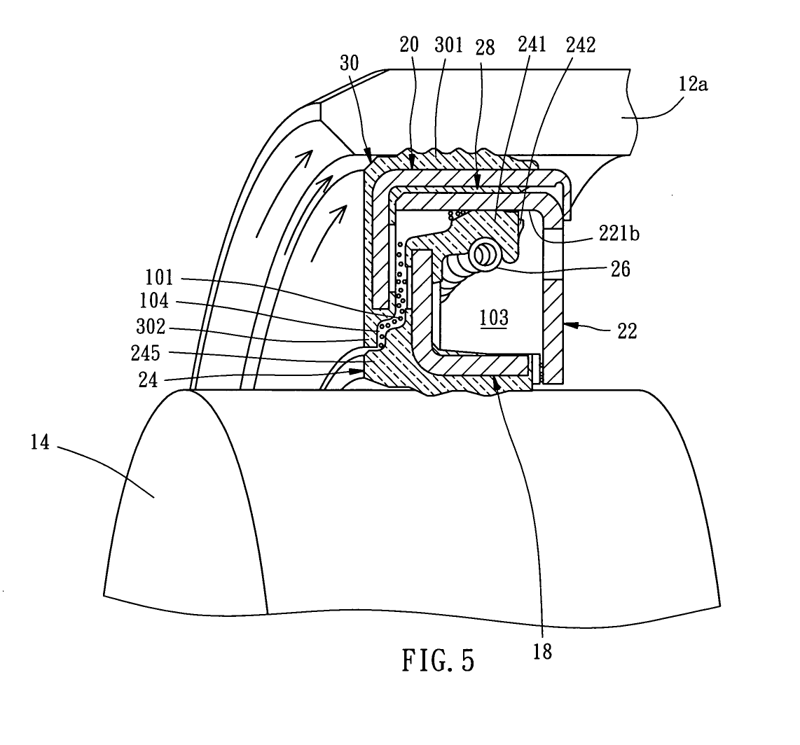

As shown in FIG. 4 and FIG. 5, the seal 10 includes an inner annular frame 18, an outer annular frame 20, a middle annular frame 22, a first sealing member 24, a spring 26, a second sealing member 28, and a third sealing member 30. The annular frames 18, 20 and 22 are metal rings fitted to each other along the same axis to be the main structure of the seal 10. The sealing members 24, 28 and 30 are made of plastic with well flexibility. The details of above elements are described hereunder:

The inner annular frame 18 has an inner plate 181 parallel to the shaft 14 and a lateral plate 182 projected outwardly from an edge of the inner plate 181. The inner plate 181 has an exterior side 181a and an exterior side 181b.

The outer annular frame 20 is fitted to the inner annular frame 18, which has an outer plate 201 parallel to the shaft 14 and a rear stop plate 202 and a positioning plate 203 projected inwardly from opposite edges of the outer plate 201 respectively. The outer plate 201 has an exterior side 201a and an interior side 201b.

The middle annular frame 22 has a middle plate 221 parallel to the shaft 14 and a front stop plate 222 projected inwardly from an edge of the middle plate 221, as shown in FIG. 4. The middle plate 221 is located between the inner plate 181 and the outer plate 201 and adjacent to the outer plate 201. The middle plate 221 has an interior side 221a and an interior side 221b. The front stop plate 222 is located at a side of the inner annular frame 18 opposite to the rear stop plate 202, which has a plurality of apertures 222a around the tank 12b. It is noted that the middle annular frame 22 is forced by the positioning plate 203 to touch the front stop plate 222 so that the middle annular frame 22 will not loose from the other annular frames.

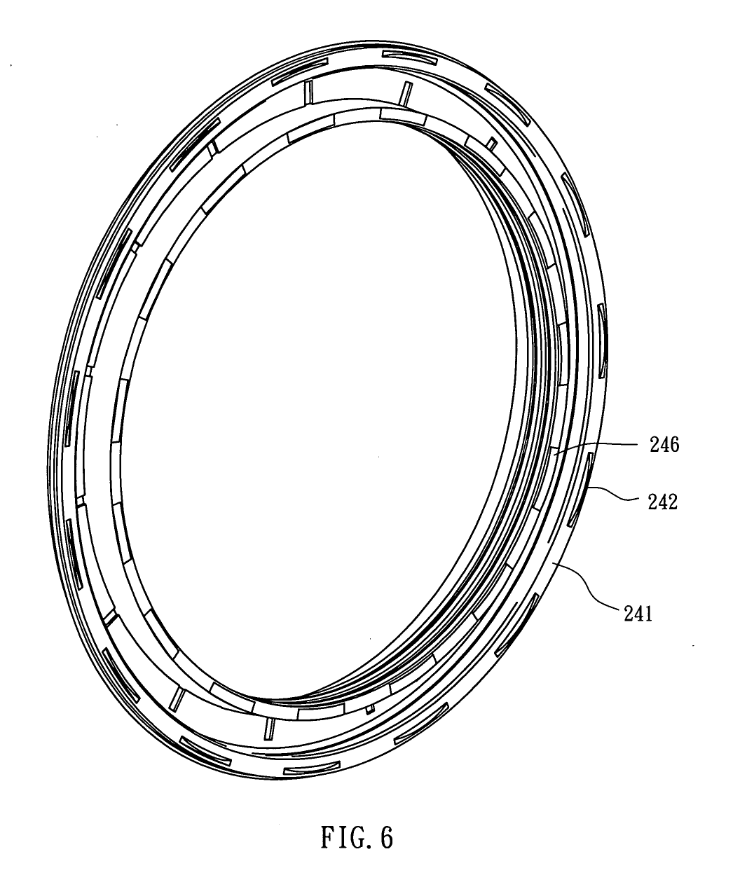

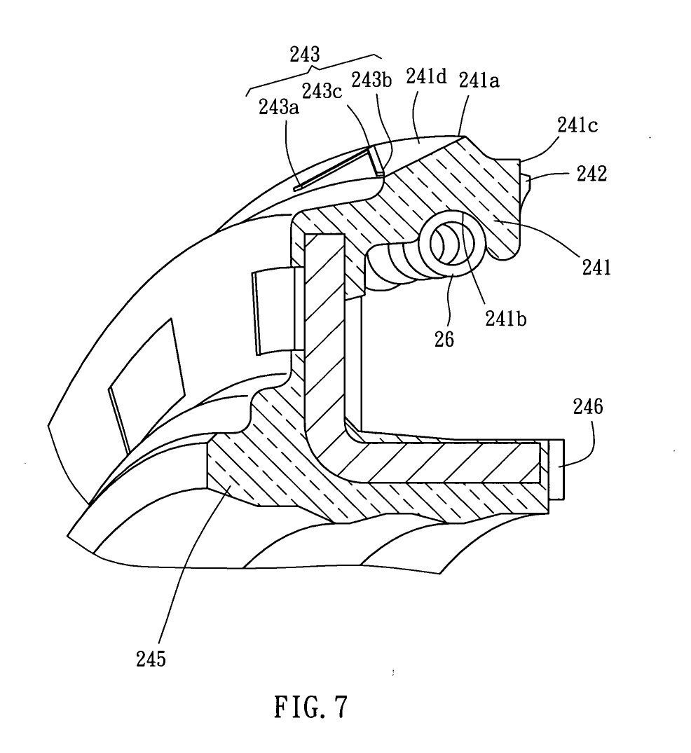

As shown in FIG. 6 and FIG. 7, the first sealing member 24 is provided on the inner annular frame 18, which has a main 241, a plurality of flanges 242, a plurality of helixes 243, an inner sealing layer 244, a first lip 245 and a plurality of protrusions 246.

The main lip 241 is connected to a top of the lateral plate 182 with a tip 241a on a top thereof and a spring slot 241b on a bottom thereof. A spring 26 is received in the spring slot 241b to urge the main lip 241 with the tip 241a deformedly pressing the interior side 221b of the middle plate 221. The main lip 241 has a front side 241c, on which the tip 241a is provided, facing the front stop plate 222 and a rear side 241d opposite to the front side 241c and facing the rear stop plate 202.

The flanges 242 are projected from the front side 241c of the main lip 241 with a circular pattern.

The helixes 243 are projected from a rear side 241d of the main lip 241 in a circular pattern. FIG. 7 shows the helixes 243 with a V shape, each of which has a first free end 243a and a second free end 243b and a turn point 243c between the free ends 243a and 243b. The turn point 243c closes to the tip 241a. In addition, the seal 10 has grease 101 between the rear side 241d and the interior side 221b of the middle plate 221 to enhance the sealing and lubrication.

The inner sealing layer 244 is provided on the exterior side 181a of the inner plate 181, which has a waved surface to deformedly press the shaft 14.

The first lip 245 points the rear stop plate 202, which has a waved surface.

The protrusions 246 are projected from a free end of the inner plate 181 to the front stop plate 222 in a circular pattern and with the same interval. Grease 101 is filled in a gap 102 between the protrusions 246 and the front stop plate 222. An oil channel 103 is formed within the inner annular frame 18, the middle annular frame 22, the main lip 241 and the protrusions 246, which is communicated with the tank 12b via the apertures 222a.

The second and third sealing members 20 and 30 are made in a single unit in the present embodiment. The second sealing member 20 is provided on the interior side 201b of the outer plate 201 and deformedly and tightly presses exterior side 221a of the middle plate 221 of the middle annular frame 22.

The third sealing member 20 includes an outer sealing layer 301 on the exterior side 201a of the outer plate 201 and a second lip 302 projected outwardly from an free end of the rear stop plate 202.

The outer sealing layer 301 has an exterior surface tightly and deformedly pressing the sidewall 12a of the hub 12, therefore the outer annular frame 20 is rotated along with the hub 12 when the hub 12 rotates relative to the shaft 14, and, in the meantime, the middle annular frame 22 is rotated simultaneously through the contact of the second sealing member 28 and the middle plate 221.

A tunnel 104 is formed between the second lip 302 and the first lip 245, in which grease 101 is filled to enhance sealing and lubrication.

Above are the description of the elements of the seal 10 of the present invention, and the functions of the seal 10 are described hereunder:

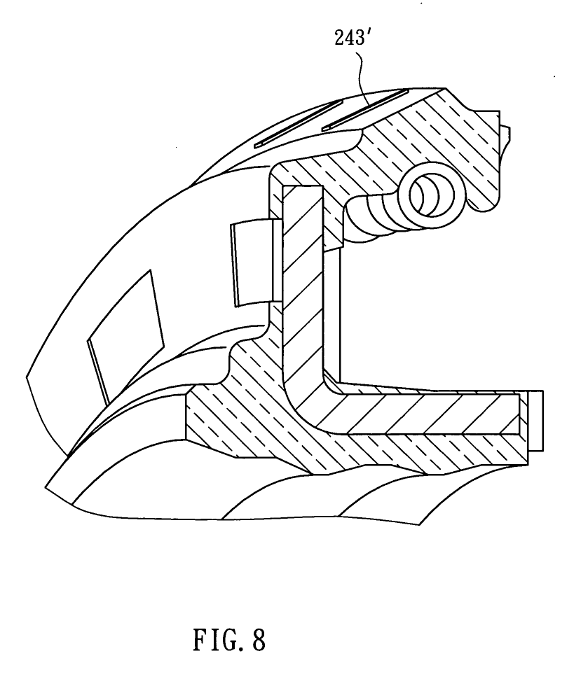

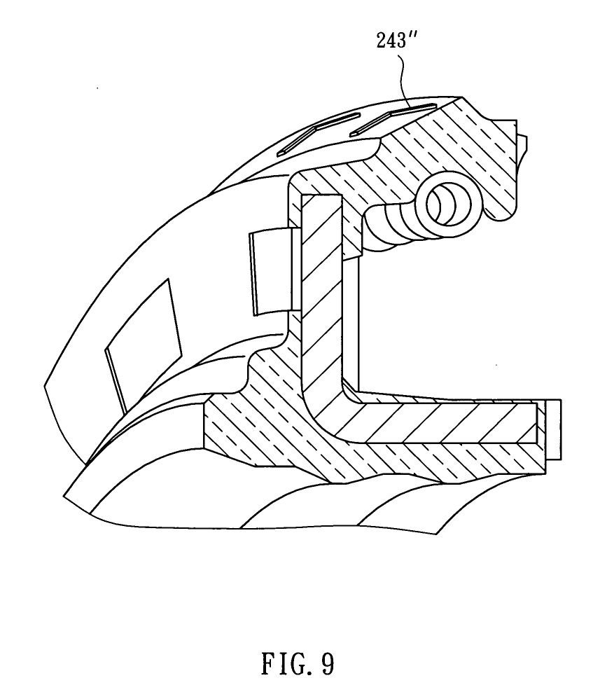

FIG. 5 shows the hub 12 rotating relative to the shaft 14 to rotate the outer annular frame 20, the middle annular frame 22 and the second and third sealing members 28 and 30 relative to the inner annular frame 18 with the first sealing member 30. It will cause the lubricator 16 flowing between the tank 12b and the oil channel 103. Meanwhile, the lubricator 16 in the oil channel 103 will be interfered by the protrusions 242 to enhance the convection effect that can reduce the corrosion effect of the rubber sealing members by the temperature of lubricator to extend the product life of the seal 10. The helixes 243 reduce the condition of the lubricator over the lip 241a flowing back to the oil channel 103 to enhance the sealing. The helixes 243′ may be made as shown in FIG. 8 in a straight-bevel shape. The helixes 243″ also may be made as shown in FIG. 9, which consists two straight sections. These helixes may enhance the sealing effect.

The rubber sealing members in the seal 10 of the present invention will be deteriorated after a long time of use that will cause the sealing effect gone worse, so that the seal 10 has to replace. The seal 10 has the inner sealing layer 244 pressing the shaft 14 and the outer sealing layer pressing the sidewall 12a of the hub 12 to be firmly fixed between the shaft 14 and the hub 12. To disassemble the seal 10, the flexibility of the rubber will help the seal 10 to be drawn out of the shaft 14 and the hub 12, and replace a new one. It doesn't have to break any part of the seal 10 of the present invention for replacement.

The present invention provides the rubber second sealing member 28 between the metal outer and middle plates 201 and 221 that can prevent the lubricator 16 in the tank 12b from leakage and prevent the outer and middle plates 201 and 221 from wear. The flexibility of the second sealing member 28 also can give a tolerance between the outer plates 201 and the middle plates 221 to take the size and level difference of the outer and middle plates 201 and 221 by the deformation of the second sealing member 28 and the outer sealing layer 301 to keep a well sealing property.

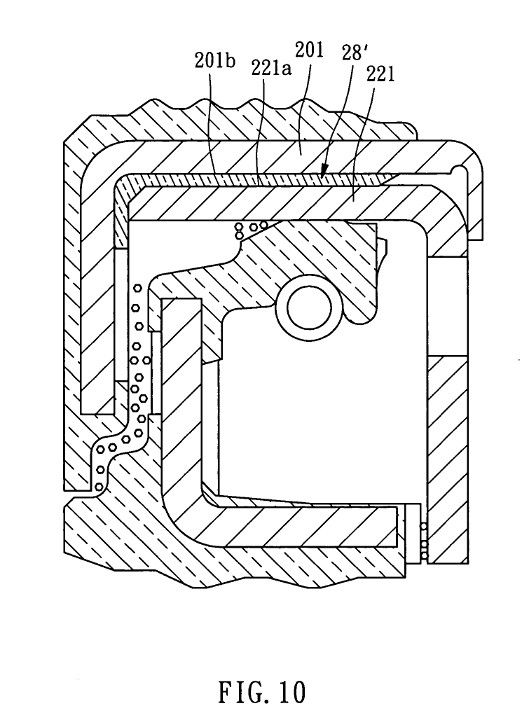

The second sealing member 28 and the third sealing member 30 may be two independent units. As shown in FIG. 10, the second sealing member 28′ is molded on the exterior side 221a′ of the middle plate 221 directly with an exterior surface tightly touching the interior side 201b of the outer plate 201. That has the same sealing effect as above.

Although the invention has been explained in relation to its preferred embodiment, it is to be understood that many other possible modifications and variations can be made without departing from the spirit and scope of the invention as hereinafter claimed.

What is claimed is:

1. A seal, comprising:
an inner annular frame having an inner plate parallel to an axis;
an outer annular frame, which is fitted to the inner annular frame, having an outer plate parallel to the axis;
a middle annular frame having a middle plate parallel to the axis, wherein the middle plate is located between the inner plate and the outer plate;
a first sealing member having a main lip connected to the inner annular frame, wherein the main lip has an end touching an interior side of the middle plate; and
a second sealing member between the middle plate of the middle annular frame and the outer plate of the outer annular frame having opposite sides thereof touching an exterior side of the middle plate and an interior side of the outer plate.

2. The seal as defined in claim 1, further comprising a third sealing member with an outer sealing layer provided on an exterior side of the outer plate, wherein the first sealing member has an inner sealing layer provided on an exterior side of the inner plate.

3. The seal as defined in claim 2, wherein the second sealing member and the third seal are made in a single unit.

4. The seal as defined in claim 2, wherein second sealing member is provided on the exterior side of the middle plate and presses the interior side of the outer plate.

5. The seal as defined in claim 2, wherein the inner annular frame has a lateral plate extended outwardly, and the outer annular frame has a rear stop plate extended inwardly, and the middle annular frame has a front stop plate extended inwardly, on which at least an aperture is provided, and an oil channel is formed between the inner annular frame and the middle annular frame to be communicated with the aperture of the front stop plate.

6. The seal as defined in claim 5, wherein the outer annular frame further has a positioning plate touching the front stop plate of the middle annular frame.

7. The seal as defined in claim 5, wherein the first sealing member further has a first lip pointing to the rear stop plate and at least a protrusion pointing to the front stop plate, and the third sealing member further has a second lip provided on the rear stop plate, and a tunnel is formed between the first lip and the second lip, and a gap is formed between the protrusion and the front stop plate, and lubricator is filled in the tunnel and the gap.

8. The seal as defined in claim 7, further comprising a spring received in a spring slot on the first sealing member to urge an end of the main lip pressing the interior side of the middle plate.

9. The seal as defined in claim 8, wherein the main lip has a tip touching the interior side of the middle plate, a front side facing the front stop plate, a rear side facing the rear stop plate, wherein the front side and the rear side are at opposite sides of the tip, and a plurality of flanges projected from the front side of the main lip in a circular pattern.

10. The seal as defined in claim 8, wherein the main lip has a tip touching the interior side of the middle plate, a front side facing the front stop plate, a rear side facing the rear stop plate, wherein the front side and the rear side are at opposite sides of the tip, and a plurality of helixes projected from the rear side of the main lip in a circular pattern.

11. The seal as defined in claim 10, wherein each of the helixes has a first free end, a second free end and a turn point between the first free end and the second free end and adjacent to the tip.
